(19) United States
(12) Patent Application Publication
(10) Pub. No.: US 2025/0170542 A1
(43) Pub. Date: May 29, 2025

(54) SYSTEMS AND METHODS FOR USING EXTERNAL AND INTERNAL REACTORS TO PRODUCE AND USE A CUSTOM TREATMENT FLUID TO CHANGE THE INTERNAL CONDITIONS OF PILES

(71) Applicant: Differential Engineering Inc., Reno, NV (US)

(72) Inventor: Thomas Joseph Seal, Reno, NV (US)

(21) Appl. No.: 18/842,766

(22) PCT Filed: Feb. 27, 2023
(86) PCT No.: PCT/US2023/063366

§ 371 Date: Aug. 29, 2024

Related U.S. Application Data
(60) Provisional application No. 63/268,738, filed on Mar. 1, 2022.

(51) Int. Cl. B01J 3/04; B01J 3/00; B01J 3/02; E21B 43/112; E21B 43/25

(52) U.S. Cl. CPC B01J 3/046; B01J 3/002; B01J 3/02; E21B 43/112; E21B 43/255

(57) ABSTRACT

Disclosed herein are systems that include a customized treatment fluid created in an exterior reactor which is delivered into a cased well, then into the heap or pile to open or stimulate new horizontal and vertical fluid pathways or channels thereby creating a second reactor in the interior of the heap or pile. One or more reagents can undergo physical changes, chemical, catalytical, biochemical, and/or biological reactions when added, mixed, and pressurized in the exterior reactor to make the treatment fluid. These mixed and pressurized treatment fluids are introduced into the heap or pile, to change one or more of the physical, biological, microbiological, or chemical conditions of the pile in an internal pressurized second reactor to improve metal recovery or change the target material in the pile.

### RELATED APPLICATIONS

This application claims priority to U.S. Provisional Patent Application No. 63/268,738, filed Mar. 1, 2022, and titled SYSTEMS AND METHODS FOR USING EXTERNAL AND INTERNAL REACTORS TO PRODUCE AND USE A CUSTOM TREATMENT FLUID TO CHANGE THE INTERNAL CONDITIONS OF PILES, which is incorporated herein by reference in its entirety.

### TECHNICAL FIELD

The present disclosure relates to heap or pile, leaching and related processes.

### BACKGROUND

Many industrial, commercial, and residential materials are placed in piles and impoundments, prior to manufacturing and processing for market. Materials may also be placed in piles, dumps, landfills, sanitary landfills, stockpiles and impoundments for storage and disposal, both short and long term. Examples include mine waste rock dumps, municipal solid waste dumps, and any-placed dumps or piles. In addition, a common technique for extracting metal from ores and other mineral material is heap leaching. In heap leaching, mined products are placed in piles and impoundments for treatment. An engineered heap of fractured, fragmented, un-consolidated rock or particulate material may be constructed, typically over an engineered liner and liquid collection system for metal, chemical and mineral extraction. A leach solution is applied to the pile surface and percolated through the heap to contact the material and dissolve one or more metal and minerals of interest into the leach solution. Sprinklers are occasionally used for irrigation of the heap, but drip irrigation is more commonly used to minimize evaporation and more uniformly distribute the leaching solution. The solution, called a “barren solution or raffinate,” containing metal and mineral dissolving reagents or lixiviants, percolates through the heap, leaches the target metal/chemical/mineral/substance, and dissolves other materials. This process, called the “leach cycle,” can take between a couple of days to months or years depending on the material being leached. Waste rock, industrial feedstocks, and all types of waste products may be stacked in piles with or without liners, depending on, for example, the material which makes up the pile, existing regulations and storage practices and the downstream processes which may involve short or long-term disposal.

Theoretically, in heap leaching, the barren solution or fluid travels substantially vertically through the heap in a fairly uniform manner from each drip or irrigation point due to gravity, which is based on the physical and mineral characterization of the material stacked (i.e., its size, voidage, permeability, compaction, etc.) in the formation of the heap or in the material placed underneath each drip or irrigation point. In reality, within a relatively short period of time, a path of least resistance, or a near vertical channel, forms in the heap, starting at each drip or irrigation point, and based on the formation or the material placed underneath the drip or irrigation point. This process is just like large surface water gradient movement from storms creating channels, troughs, and gullies from water erosion. Each path of least resistance is likely to be near vertical for permeable material and near horizontal for impermeable material, and as a result, solutions may bypass large sections or volumes of the heap or pile such that they may receive no barren solution after a period of time, and relatively little or no leaching of the target material may occur. Also, the leach solution may not uniformly contact all portions of the heap because of permeability variations existing within the heap or pile, such as volumes of clay material with low permeability. In addition, within the heap or pile, there may be material that exhibits low permeability and does not let solution or fluid pass by the force of gravity, thus entraining or pooling the solution above the low-permeable heap or pile material. Such permeability variations may result in preferential flow of the leach solution through more permeable portions of the heap, leaving volumes of under-leached or un-leached material below less permeable portions, and areas of fluid retention and saturation above these less permeable portions.

Also, the chemical and mineral properties in some portions of the heap may be less responsive to dissolution of the metal or mineral into the leach fluid. There may be an undesirable natural or precipitated sulfide or oxide mineral coating on the target metal or mineral for leaching, or mineral encapsulation of the target metal or mineral that reduces the leaching efficiency. For example, when heap leaching copper with an acid leach solution, high alkaline pH spots within the heap may not respond well to the acid leach solution and may lead to reduced permeability, chemical precipitation, and mineral encapsulation (scale), rock decrepitating, migration of fines, heap settlement and compaction, leaving those portions under-leached or un-leached as well as volumes of solution retention and pools in the heap. Metals and minerals remaining in under-leached, un-leached portions as well as pools of fluid with dissolved metals and minerals entrained in a heap during and following heap leach operations often represent a significant loss of un-recovered inventory to a mining operation.

In another example, piles of feedstock and waste may be stacked in a manner to isolate the material from the environment. The piles are often covered and lined to prevent meteoric water from reacting with constituents in the pile and impacting and/or degrading surface and ground water. In most heap leaching, a heap collection system collects the resulting pregnant leach solution (i.e., the solution containing the products (metals, minerals and chemicals) of chemical dissolution reactions or leaching) drained from the liner and the pregnant solution is then processed to recover the dissolved metal and minerals. Once the target material (including mineral and metal) has been removed from the pregnant solution via a recovery process, the once again barren or raffinate solution, often containing additional reagents and added lixiviants from processing, may be reused in the heap leach process by pumping the barren solution back to the top surface of the heap or treated further to remove certain undesirable chemicals or constituents.

A common problem with heap leaching is the non-uniform fluid flow or solution channeling, through a heap and resultant incomplete leaching of metals from the heap. Even after extensive leaching over time, some portions of the heap may remain under-leached or even substantially un-leached. In addition, this problem is often associated with uneven permeability of the material placed as a heap, with heap compaction, chemical precipitation, metal and mineral encapsulation, rock and mineral decrepitation, and migration of fines, which separately or together can result in a pool of fluid above a low permeable zone. This pool may be of significant tenor or grade with a large quantity of pregnant solution and may also contain considerable unrecovered metal and mineral values. This pool can migrate in a near horizontal direction and daylight on the side slope of the heap or pile because of the fluid head build up from applied solutions and meteoric rain and snow. The presence of an internal fluid pool within a heap increases the total weight of the heap on the foundation and liner, (example, dry weight compared to wet, saturated weight) and lubricates the heap material thereby significantly reducing the inter-particle cohesion and friction. The undrained weight added to the reduced friction and reduced cohesion for the material in the heap can impact the heap's integrity and geotechnical stability leading to heap movement and failure.

Heap leaching ore generally has a lower metal recovery than grinding and tank leaching of most ores. The finer grind and particle liberation by milling will enhance the surface area of the particles thus improving the leaching kinetics and metal recovery. However, mills, tanks and tails disposal represent a large capital, operational and reclamation expense. Heap leaching is less capital and operator intensive and the heaps and solutions are contained within an engineered lined facility.

Man-made piles of manufacturing feedstocks and post processing or use, are also dumped in stacks and piles, like landfills, some lined and some on natural soil. These piled materials may respond to the natural elements of sunlight, rain, snow, wind, and seasons temperatures and depending on the composition of the material in the pile, may react producing products or byproducts that may impact the environment via fluid pathways in a negative way.

### BRIEF DESCRIPTION OF THE SEVERAL VIEWS OF THE DRAWINGS

The written disclosure herein describes illustrative embodiments that are non-limiting and non-exhaustive. Reference is made to certain of such illustrative embodiments that are depicted in the figures, in which:

FIG. 1 is a schematic of a dual reactor diagram with an exterior reactor 200 being fed reagents and/or components from 100 and 300, then conveying a custom high pressure treatment fluid to a heap or pile 700 via conduits and a vertical well 500 to a second internal reactor 600 or zone in the heap and pile 700, below the surface of the pile 400 and above a liner or native earth 800.

FIG. 2 is a schematic of an external high pressure reactor system that utilizes the methods described of adding customized reagents, chemicals, solids, liquids, reagents, and/or gasses to feed a pump thereby increasing the pressure of the system from the external first high-pressure reactor down a vertical well to a targeted zone in the heap or pile.

FIG. 3 is a schematic of an exemplary external high-pressure reactor and depicts the general equipment and process of the external high-pressure reactor for creating a custom pressurized treatment fluid via pumping.

FIG. 4 is another schematic of an example of an external high-pressure reactor and depicts the general equipment and process of the external high-pressure reactor for creating a custom pressurized treatment fluid via use of a compressor.

FIG. 5 depicts a well 500 installed in the heap or pile 700 above the bottom of the pile 800, such as the pile depicted in FIG. 1. FIG. 5 shows a perforated portion of a drill casing, isolation mechanisms, and a potential zone of influence created by injection of a custom pressurized treatment fluid.

FIG. 6 depicts a well 500 installed in a heap or pile 700 above the bottom of the pile while undergoing injection of a custom pressurized treatment fluid thereby creating a second internal reactor.

FIG. 7 is a schematic example of an external low-pressure reactor and depicts the general equipment and process of the external low-pressure reactor for creating a custom pressurized treatment fluid via a vacuum created by a falling fluid.

FIG. 8 depicts a portion of a well installed in a heap or pile 700 above the bottom of the pile 800, such as the pile depicted in FIG. 1. FIG. 8 shows a perforated portion of a drill casing, isolation mechanisms, and a potential zone of influence created by injection of a custom pressurized treatment fluid.

### DETAILED DESCRIPTION

A system and method for rechanneling fluid flow in a heap or pile to recover a target material or change the biological, chemical, microbiological, and physical properties of the pile is described. The system includes an exterior first reactor, a customized pressurized treatment fluid, then transports this fluid to one or more drilled well casings, a pipe, isolation mechanisms, and a control valve(s). The drilled well casing is positioned substantially vertically within a heap or a pile with a variety of well depths and may be installed with a variety of drilling technologies using a variety of materials selected for the drill casing. Additionally, the drilled well casing includes an open top, an open or closed bottom, and at least one perforation zone having perforations along a vertical section of the drilled well casing. Additional wells may be installed with a closed bottom to facilitate well installation using other well installation technology. The pipe is positioned within the drilled well casing and the pipe is configured to receive the pressurized treatment fluid which create a second internal reactor or zone in the heap or pile. This zone dimensions, size, shape, volume, and pressure profile is controlled by the customized pressurized treatment fluid's quantity, flow and mass controls, thus controlling the mass of material in the heap or pile impacted by the customized treatment fluid. The pressure profile of the injected fluid in the targeted zone has a maximum at the casing perforations and transports that pressure generally by near horizontal rechanneled pathways outward until the summation of the material's permeability allows fluid leak-off upward and downward due to gravity until an equilibrium is reached. This equilibrium is unique to the physical properties of the material in the zone.

Embodiments discussed herein relate to systems and methods for improving the H₂O I/E, as further described below, in heaps and piles. The systems and methods described herein recover a target material, alter the biological, chemical, biochemical, microbiological, and/or physical properties of the material, by using a customized pressurized treatment fluidization process. The customized pressurized treatment fluidization process or method may operate independently of other systems, methods, and/or processes. However, the customized pressurized treatment fluidization also may be used in conjunction with other systems, methods, and/or processes. For example, the customized pressurized treatment fluidization process presented herein may be integrated with other JEX technologies, as further described below. By way of further example and not of limitation, the illustrative embodiments include combining the pressurized treatment fluidization process with systems, methods and apparatuses described in U.S. Pat. Nos. 9,050,545; 9,513,055; 9,752,207; and 10,155,255 each of which is incorporated herein by reference, and which may also be referred to as the “JEX technologies,” and that name the same inventor as the present application.

JEX and HYDRO-JEX® are trademarks used by Differential Engineering Inc. “JEX” or “JEX Technologies” refers to the process of using the new high-pressure injection to stimulate channels in a pile for biological, biochemical, chemical, microbiological, and/or physical change in the pile and metal, chemical, and/or mineral extraction. This process is also referred to herein interchangeably as “I/E” or the “I/E process.” In general, HYDRO-JEX® refers to a process for a particular use of water chemistry in the I/E process, such as illustrated in U.S. Patent Publ. No. US2015/0275327, which is incorporated herein by reference, and is referred to herein as “H₂O I/E.” or the “H₂O I/E process.” The term “I/E technologies” is used to refer to the I/E processes and H₂O I/E processes.

The systems, methods, processes, and/or apparatus presented herein are referred to as “customized pressurized treatment fluidization,” which incorporates customized reagent addition with the pressurized treatment fluidization process. By way of example and not of limitation, customized pressurized treatment fluidization may be integrated with the I/E process, the H₂O I/E process, or any combination thereof. More specifically, pressurized treatment fluidization refers to the pressurized treatment fluidization of particles that occurs when fluid is added with sufficient pressure, momentum, and force to move a particle or impart a momentum to a resting particle in a pile. In some of the illustrative embodiments, the systems and methods presented herein employ pressurized treatment fluidization in the interior of a pile or in situ, thereby being confined and contained by the surrounding material of the pile for a designated period of time to minimize the impact on the pile's geostability. By way of example and not of limitation, customized pressurized treatment fluidization may be used to create in the exterior first reactor a custom treatment fluid that is transported and introduced into an identified heap location or zone to create a second, internal in the pile, pressurized reactor to recover the target material, metal and, mineral and/or to alter the biological, biochemical, chemical, microbiological, and/or physical properties of the targeted pile material, resulting in one application of many that being metal and mineral extraction. In other applications to change the biological, biochemical, chemical, microbiological, and/or physical properties of the customized pressure treatment fluid or material in the targeted zone in the pile.

In one illustrative embodiment, the H₂O I/E process incorporates the pressurized treatment fluidization process in heaps and piles as described in further detail herein. Customized pressurized treatment fluidization systems, methods and apparatus have shown significantly improved kinetics when compared to normal atmospheric pressure and temperature leaching in a heap or tank for the same size of material. The term customized relates to a process of examining the minerology and composition of the material in the pile and selecting a customized mixture of pressurized treatment fluid that comprises one or more of treatment reagent(s) and/or compounds, a metal treatment reagent(s), a lixiviant, solid reagents, liquid reagents, gasses, anions, bacteria, catalysts, cations, chemicals, elements, enzymes, hazardous materials, inorganic solutions, lixiviants, organic solutions, penalty metals, reagents, scale inhibitors, slurries, solvents (both inorganic and/or organic), and surfactants, reactor feed fluids which could include any combination of: gas or gasses, water, inorganic and/or organic liquids, solutions and slurries, an added biochemical and/or chemical reagents to alter one or more of the treatment fluid such as chemical reactions of: acid-base, catalytic, coagulation, combination, complexation, dissolution, dissociation, displacement, dispersion, enzymatic, growth, hydrolysis, ionization, compound modification, neutralization, pH, precipitation, polymerization, oxidation, reduction, scale inhibition, chemical stability, and substitution. In addition, the reactor can facilitate biological and microbiological processes and reactions including, but not limited to, biosynthesis, catabolism cultivation, dispersion, enzymatic, growth, hydrolysis, inoculation, mixing, mutation, adding nutrients, oxidation-reduction, reproduction, respiration, substrate introduction, synthesis, transformation, transportation, and make or modify products, plus physical changes and processes such as, conductivity, density dispersion, dissolving, drying, filtering, fluidization, mixing, phase, polarity, and volume changes, solubility, geotechnical stability, surface tension, particle surface charge, temperature, viscosity, and wetting. Thus, the reactor systems can create a high pressure biochemical, biological, chemical, catalytical, and/or physical reactor taking feed from one or more components and reagents of customized mixtures of solids, liquid and gasses, bacteria, thereby improving the reaction kinetics, to make a treatment fluid in the first external reactor that is then injected into a heap or pile creating a second internal to the pile reactor.

Fluids introduced into a near vertical cased well by gravity fluid flow do not achieve sufficient head or pressure to substantially fluidize or move particles in a productive manner because the in-situ pile pressure is greater than the pressure imparted by the flow of fluid from a gravity well. Thus, the gravity cased well fluid flow will not achieve a significant near horizontal wetting impact and will not rechannel fluid pathways in the pile. In fact, gravity fluid flow in a cased well often promotes fluid build-up and pooling leading to pile movement, instability, and failure.

In the illustrative embodiments presented herein, the customized pressurized treatment fluidization process described herein can be used with a particular material with significant compounds or specific mineral characteristics, that can be specifically placed in a designed and specified location in a pile with the purpose of using the customized pressurized treatment fluidization systems, methods and apparatus for biochemical, biological, chemical, geotechnical, physical results, treatment or any combination thereof. Thus, the I/E technologies are not limited to mature or existing heaps and the I/E technologies (in combination with pressurized treatment fluidization) can be used to recover a target material and to alter the biological, chemical, biochemical, microbiological, and physical properties of the material of any reactive compound or material in virtually any pile.

Similarly, H₂O I/E technologies, like HYDRO-JEX®, can also be used in stages to accommodate various different biological, chemical, biochemical, and/or microbiological pressurized reactions, plus changes in the physical conditions of a pile in time. By altering one or more parameters such as the induced pressure, reagents, lixiviants, pH, Eh, fluid physical and biological, biochemical, chemical, and/or microbiological properties, (i.e., mixtures of solids, liquids, gasses and bacteria, catalysts, scale inhibitors, surfactants and enzymes, plus one or more of pumpable and compressible material) and time for the biochemical, biological, chemical, microbiological reactions, plus physical property changes to occur during rest periods for specific zones in a pile, the material in the pile can then be subjected to separate stage when a host of various conditions to promote one or more of additional selected biological, biochemical, chemical, microbiological products or conditions that favor the desired effect of altering the conditions in a pile, leaching metals, storing material, stabilizing the physical properties and closing a pile.

Without being bound by any particular theory, the promotion of zonal biooxidation of pile material in a second internal reactor over time, followed by altering the pH in the zonal conditions in the heap or pile, for metal dissolution or leaching, allows increased leaching of precious metals, e.g., gold, or optimally leach silver.

Other examples include but are not limited to leaching soluble base metals under a variety of, biological, chemical, microbiological, and/or physical zonal conditions followed in time by altering the biological, chemical, microbiological, and/or physical conditions to leach a target mineral or metals. The reverse may also be utilized, by leaching a first metal then later altering the biological, biochemistry, chemical, and/or microbiological properties of a zone to leach a second metal (or additional metals). In addition, the biological, biochemistry, chemical, and/or microbiological properties of the zones can be altered for long term storage of pumpable and/or compressible material that may be hazardous or for closure of a pile with negligible impact on the environment.

The customized pressurized treatment fluidization processes can be used in combination with the I/E technologies for detailed planning and placement of material on a heap leach pad, pile, dump, landfill, sanitary landfill, and impoundment for one or more reasons: (i) enhance metal and mineral production, ii) target and change the biological/biochemical/chemical/microbiological/physical status and properties, and/or (iii) improve geotechnical stability. Embodiments may be incorporated in existing and mature heaps, piles, dumps, landfills, sanitary landfills, and impoundments, to utilize in situ customized pressurized treatment fluidization of the material to improve reagent utilization, metal, chemical and mineral extraction and selected, designed biological, biochemical, chemical, microbiological reactions, and kinetics. As discussed herein, detailed planning and placing of selected material in heaps, piles, dumps, landfills, sanitary landfills, and impoundments may be used, for example, in various I/E technologies for optimal metal recovery, improved geotechnical stability, adjustment of biological, biochemical, chemical, microbiological or physical properties, and enhanced closure stability. The present disclosure involves the technologies using customized pressurized treatment fluidization in the planned construction and stacking of heaps, piles, dumps, landfills, sanitary landfills, and impoundments, and may include segregated placement of material with specific physical and biological, biochemical, chemical, microbiological properties. Material may be placed at specific locations in a heap, pile, dump, landfill, sanitary landfill, or impoundment in order to incorporate the I/E technologies, e.g., JEX technologies, in addition to using the pressurized treatment fluidization technologies disclosed herein.

Terms used throughout this disclosure include pile, heap, dump, impoundment, landfill (commercial, garbage, governmental, industrial, municipal, sanitary, stacks, stockpiles) or any man-placed mass or material accumulated, stacked, vertical piled or placed for temporary, short term, long term or permanent storage. A pile includes stacked and/or placed material above native soil, with a foundation or visible separation. A heap leach pad is a pile with a liner and a collection system to contain and recover the pregnant solution (fluids containing products of leaching and chemical reactions), below the stacked material for metal, chemical and mineral extraction. Piles, dumps, landfills, sanitary landfills, stacks, and impoundments may have material placed with confining sides to contain solids and liquids, but generally do not have a bottom collection system. An impoundment may be lined and may have a surface solution collection system.

In the illustrative embodiments, one or more wells having a perforated well casing are installed into a pile, or heap, which will be leached, biological, biochemical, chemical, microbiological or physically altered, and impacted. The well includes one or more perforated sections, i.e., zones, which are designed such that during a fluid stimulation, e.g., a customized treatment fluid injection under pressure, the fluid impacts a zone or geometric volume of the heap or pile. The volume of the heap or pile affected by the fluid depends upon fluid pressure, volume, and location of the zone isolation mechanisms.

In embodiments, a customized treatment fluid containing one or more formulated mixtures of one or more solids, liquids, gases, anions, bacteria, catalysts, cations, chemicals, elements, enzymes, hazardous materials, inorganic solutions, lixiviants, organic solutions, penalty metals, reagents, scale inhibitors, slurries, solvents (both inorganic and/or organic), surfactants, water, and/or inorganic and organic liquids may be delivered into the cased near vertical well through one or more conduits or pipes and may include meteoric water traveling through the pile to fit the pile treatment application. The customized treatment fluid may thereafter be screened, pressurized, mixed in the first exterior reactor and delivered, for example by being introduced under pressure required for delivery of the fluid through a perforated well, deep into a heap leach pad or pile to create a second internal reactor in the targeted material or zone to promote one or more of the following processes: leach, re-leach, promote select biological, biochemical, chemical, microbiological reactions, and/or to physically change the zone with augmented reaction kinetics by incorporating customized pressurized treatment fluidization to alter and/or change the biological, biochemical, chemical, microbiological, and/or physical properties, and/or to dry, wet, and/or rinse extracted components of interest (such as metals for recovery), and/or to promote long term pile physical, geotechnical, biological, biochemical, chemical, microbiological, and/or physical characteristics. The high-pressure delivery method may open or stimulate new fluid pathways or channels by fluidizing and moving the particles in the pile, thereby creating new channels, and allowing fluids to interface with the target zone for treatment under pressure. The process does not involve hydraulic fracturing of the material but relies upon pressurized treatment fluid rechanneling through void spaces in the stacked material. The system may include a mobile apparatus (e.g., a mobile trailer or skid) installed near or at the vicinity of the injection well.

In the main illustrative embodiment, the H₂O I/E process incorporates the customized pressurized treatment fluidization process in heaps and piles as described in further detail herein. Upon examination of the mineralogical, physical, biological, microbiological, biochemical, and/or chemical properties of the material in the pile, plus identifying the desired biological, biochemical, microbiological, physical, and/or chemical reactions to take place in each targeted zone in the pile, a customized treatment fluid is designed to make up the pressurized fluid. These customized, formulated reagents are added or metered into the H₂O I/E process and mixed under pressure transforming the reagents by one or more biological, biochemical, chemical, microbiological, and/or physical process to make a new treatment solution or customized pressurized treatment fluid in the first external reactor that is delivered through a perforated well, deep into a heap leach pad or pile. Thus this system comprises a high pressure biochemical, biological, chemical, catalytical, microbiological, and/or physical process reactor taking feed reagents of one or more formulated mixtures of one or more solids, liquids, gases, anions, bacteria, catalysts, cations, chemicals, elements, enzymes, hazardous materials, inorganic solutions, lixiviants, organic solutions, penalty metals, reagents, scale inhibitors, slurries, solvents (both inorganic and organic), and/or surfactants to accomplish a designated biological, microbiological, biochemical, and/or chemical and physical process under pressure, mixing, and fluidizing, thereby improving the reaction kinetics to make a customized high pressure treatment fluid in the exterior first reactor that is then injected into a heap or pile.

As detailed above, material and particles placed in a pile will have different degrees of permeability, or the ability to allow fluids to pass down by gravity. As additional material is placed or stacked on the pile, the weight above may compress or reduce the permeability of the material below. When the permeability reaches a minimum, air conveyance and water fluids flow downward is reduced or stopped allowing the water fluids to build up or pool. This water fluid reduces inter-particle cohesion and friction within the pile and adds water fluid head and solution weight, thereby imparting reduced resistance to both pile movement and to pile geotechnical stability. As water fluid height increases, the water fluid flows laterally until the water fluid finds an area of improved permeability to then continue downward by gravity. As the volume and velocity of water fluid increases, the water fluid creates channels, just like gullies are formed with intense rainfall. These channels then provide preferential flow for the water fluid. The material below the low permeability area receives little fluid and promotes un-leached, unreacted or under leached and under reacted volumes of material in the pile. The channeled water fluid area receives excessive quantities of water fluid which dilutes the dissolved metal, chemical and minerals reporting to the pregnant solution thereby impacting the physical, biochemical biological, microbiological, and/or chemical properties of the pile's material.

In embodiments, by altering the delivery method in each zone during pressure stimulation and fluidization in the created internal second reactor, new channels and fluid pathways open by moving the particles in the heap or pile, thereby changing, or rechanneling the fluid pathways established by gravity water fluid flow. In addition, directional pressure fluidization opens drainage pathways to create additional channels or rechannels from the open cased well bottom to the bottom of the heap or pile, thereby creating a drain system in-situ in the heap or pile. The drain system may be positioned above a platform, foundation, or terrain contour, e.g., a natural contour of native earth or compacted native earth, with or without a liner, that conducts solution to a location, pond, or low spot above the natural under pile material or native earth, located down gradient from the heap or pile.

Embodiments may incorporate as the exterior first reactor: a trailer or skid apparatus, which may include instruments configured to perform a number of functions including, but not limited to, measurement of flow and pressure of the aqueous solution and other treatment fluids containing of one or more formulated mixtures of one or more solids, liquids, gases, anions, bacteria, catalysts, cations, chemicals, elements, enzymes, hazardous materials, inorganic solutions, lixiviants, organic solutions, penalty metals, reagents, scale inhibitors, slurries, solvents both inorganic and organic, and/or surfactants. The exterior first reactor may further include a high pressure, low volume compressor to inflate isolation mechanisms, a straddle zone isolation mechanism, and a control valve to isolate a specific elevation in the pile for selective treatment, injection, leaching, rinsing and/or recovery of metals, and alteration of the biological, microbiological, biochemical geotechnical, physical, and chemical properties of the material in a heap, pile or zone. Various embodiments may enable any one or more of higher flow rates, higher pressure, and delivery to increased depths, while maintaining and/or enhancing safer operations.

As used herein, the terms “heap,” “heap leach,” “dumps,” “waste dumps,” “landfill,” “sanitary landfills,” “process tails,” “stacks”, “stockpiles,” “process piles,” “garbage dumps,” “refuse,” “deposit,” “rubbish pile,” “commercial, industrial and urban waste,” “lot,” as well as any material placed in a pile for temporary storage or long term storage or disposal (collectively referred to herein as a “pile”), illustrate an application of the systems and methods described herein. The disclosed systems and methods are not limited to use with heaps and for heap leaching. Rather, the embodiments described herein apply to all piles constructed of collected material (whether lined, unlined, or contained) and/or that are open to the environment. As such, the systems and methods described herein may be used to treat any material in storage or disposal in a pile, impoundment, dump, landfill, (industrial, municipal, garbage, sanitary, which are collectively referred to herein as “sanitary”), and used for any type of percolation leaching, dump leaching, crushed leaching, ore pile leaching, run of mine leaching, bio-leaching (aerobic and anaerobic) or any other leaching methods where ore or material is placed on or over an engineered liner with a collection system, or material is placed with or without a foundation, which contains the pile plus fluid or is open to the environment, like process stockpiles, waste dumps, all of which are also collectively referred to herein as a “pile,” regardless of the design of the heap, pile, collection system pipe work, ditches, ponds, liner, drain rock and regardless of whether such piles include ore, waste, refuse, trash, garbage, or other materials.

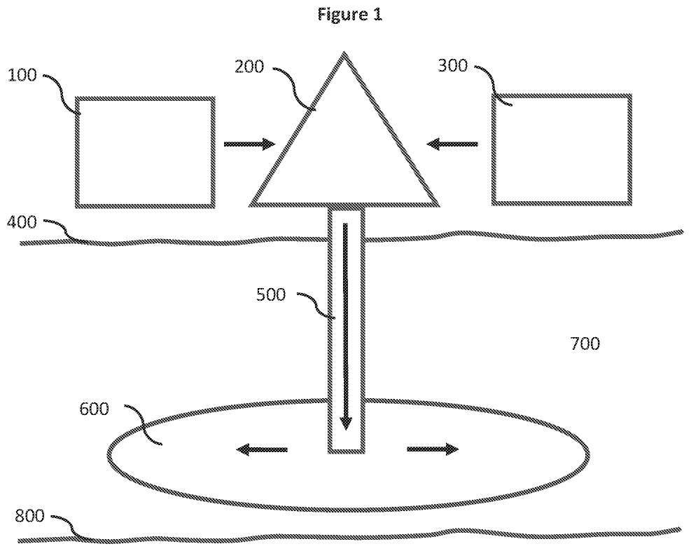

FIG. 1 depicts an embodiment of a dual reactor system comprising a heap leach pad or pile 700 and the exterior first reactor 200 being fed reagents and/or components from 100 and 300 and mixing and pressurizing reagents and/or components in the first exterior reactor, then transporting the custom pressurized treatment fluid to a cased well 500 installed in the pile 700. The addition of reagents and/or components are not limited to just one or two, 100 and 300, but can be a host of one or more reagents and components. The cased well 500 in the pile 700 has designated perforations where the custom pressurized treatment fluid is isolated in the cased well 500 to inject the custom pressurized treatment fluid into targeted material or a zone in the pile 700 thereby creating an internal second reactor 600. The lower layer 800 may be one or more of a liner, a foundation, a containment structure, or native earth, beneath the heap or pile there may be an engineered liner 800, which may include low permeable materials such as combinations or single layers of clay, high-density polyethylene (HDPE), geotechnical material, synthetic and/or natural material for containment, and cushion and/or drain layers.

FIG. 1 shows the first external reactor 200 is fed reagents and/or components from 100 and 300 that include one or more formulated mixtures of one or more solids, liquids, gases, anions, bacteria, catalysts, cations, chemicals, elements, enzymes, hazardous materials, inorganic solutions, lixiviants, organic solutions, penalty metals, reagents, scale inhibitors, slurries, solvents (both inorganic and organic), and/or surfactants which are designed uniquely for pile treatment and are metered and mixed with one or more of inorganic or organic solution or a water based parent or barren solution. These reagents are mixed, pressurized, fluidized, and undergo one or more of the following: chemical reactions of: acid-base, catalytic, coagulation, combination, complexation, dissolution, dissociation, displacement, dispersion, hydrolysis, ionization, compound modification, neutralization, pH, precipitation, polymerization, oxidation, reduction, scale inhibition, chemical stability, and substitution. In addition, this first exterior reactor can facilitate biological and microbiological processes and reactions such as biosynthesis, catabolism cultivation, dispersion, enzymatic, growth, hydrolysis, inoculation, mixing, mutation, adding nutrients, oxidation-reduction, reproduction, respiration, substrate introduction, synthesis, transformation, transportation, and make or modify products, plus physical changes and processes such as conductivity, density dispersion, dissolving, drying, filtering, fluidization, mixing, phase changes, polarity, solubility, geotechnical stability, surface tension, particle surface charge, temperature, viscosity, volume and wetting, by mixing and combining the components under pressure, to create a customized pressurized treatment fluid. The custom pressurized treatment fluid may be one or more gases, liquids, solids, and combinations thereof.

Pressurization of reagent reactions in the first external reactor 200 changes the solution free energy and increases the chemical interaction resulting in a change of concentration or solvation of the ions, reagents, and compounds with pressure, especially gasses. This physical alteration conducted in the first external reactor 200 process changes the concentration and physical properties of the customized pressurized treatment fluid. Besides customized reagent dissolved concentration, chemical species and solubility changes, there may be physical changes in the viscosity, conductivity, polarity, density, pH, Eh, temperature and surface tension of the pressurized treatment fluid delivered through a perforated well 500 deep into a heap leach pad or pile 700. Thus, this system is a high pressure biochemical, biological, chemical, catalytical, microbiological, and/or physical exterior reactor taking feed reagents of customized mixtures of reagents and compounds thereby increasing the rate of reaction due to pressure to make a custom pressurized treatment fluid.

These following examples are presented, but are not limiting to the 200 reactor process, method and pressurized external reactor system. There are additional formulated mixtures of one or more solids, liquids, and/or gases that have improved reaction kinetics when fluidized and under pressure that can be utilized:
Oxidation Example: ferrous iron to ferric iron, Fe⁺² to Fe⁺³.
Reduction Example: Anerobic sulfate reduction to H₂S or sulfides.
Dissolution Example: Improve dissolved oxygen with increased pressure, O_{2(gas)} to O_{2(dissolved)}.
Precipitation Example: Ferric iron precipitation of arsenic from solutions. Fe(OH)₃+H₃ASO₄ to FeAsO₄·2H₂O+H₂O.
Chemical reactions resulting in synthesis, decomposition, replacement, electrochemical, hydration, complexation, acid-base, substitution, with or without a catalyst. Example: Conversion to dissolved hydrogen cyanide to free cyanide by adding a base. HCN+OH⁻ to CN⁻ and H₂O.
Complexation Reaction Example: liquid ammonia and ammonia salts hydrolyze and makes a series of complexes with cyanide, one of which is NH₄CN.
Biological Example: microbiological biooxidation of sulfides, or microbiological treatment of cyanide species in water solutions.
Catalyzed Example: silver catalyzed bio-oxidation of chalcopyrite containing ores.
Physical reactions thereby changing the viscosity, surface tension, and/or wettability of the pressurized treatment fluid impacting the heap or pile. Example: Adding surfactants or surface acting agents that will lower the surface tension between the gas, liquid and solid phases resulting in more particle surface area wetting in the heap impacted by the customized pressurized treatment fluid.
Improved reaction kinetics in the pressurized treatment fluid. Example: Cyanide dissolution of gold from a flotation tails sample is 4 times faster at 90 psi than at room pressure.
pH Example: ammonia to ammonium hydroxide. NH₃+H₂O→NH₄⁺+OH⁻
Eh or oxidation/reduction potential Example: Adding hydrogen peroxide to the treatment fluid as an oxidant.
Ionization Example: Dissolve sodium hydroxide. NaOH(s) to Na⁺+OH⁻
Scale Inhibitors Example: Precipitant and scale crystal modification in heap leach fluids to reduce the coating of valuable minerals by scale with improved liquid to solid (mineral) surfaces wetting and mineral extraction.

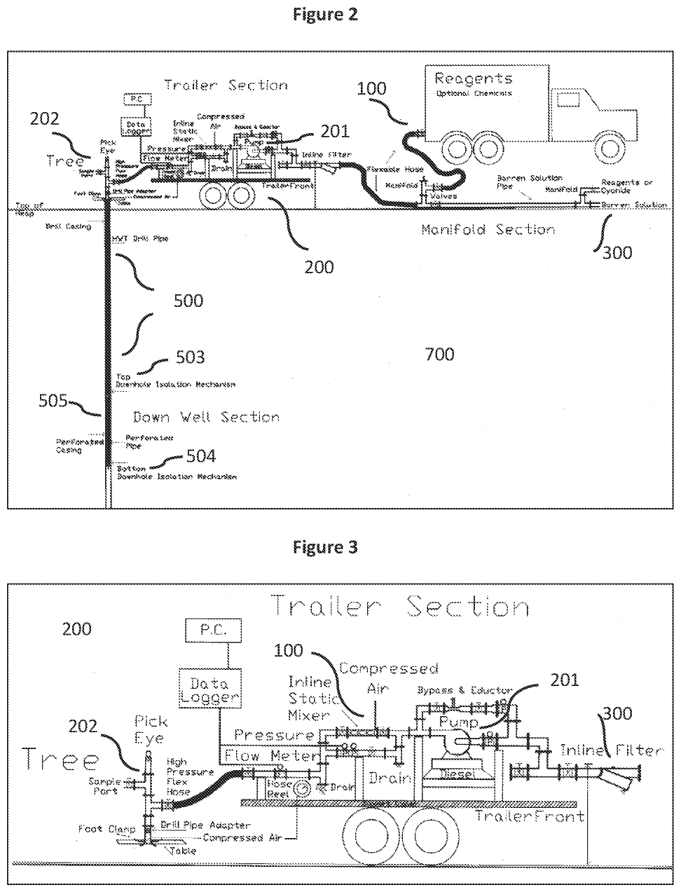

FIG. 2 is an illustration of an external high pressure reactor system 200 that utilizes the methods described of adding customized reagents 100, and one or more chemicals, solids, liquids, and/or gases 300 to feed a pump 201 (electric, gas, or liquid energy driven motor) thereby increasing the pressure of the system making the external first high-pressure reactor for the custom treatment fluid connected to the wellhead 202, down a vertical well 500 to a targeted zone 505, isolating a perforation zone 503 and 504, in the well casing 500, in the heap or pile 700. One or more zones, each comprising a plurality of perforations 505. FIG. 2 depicts the general flow sheet with equipment and process utilized as in an exemplary embodiment of FIG. 1.

FIG. 3 is an illustration of the external high pressure reactor system 200, that utilizes the methods described of adding customized reagents 100, and one or more chemicals, solids, liquids and/or gases 100, to feed a pump 201 (electric, gas, or liquid energy driven motor), thereby increasing the pressure of the system making the first high pressure reactor 200 for the custom treatment fluid connected 202 to a vertical well 500 to a targeted zone in the heap or pile 700. This embodiment depicts the general flow sheet with equipment and process for one example of the external first pressurized reactor 200 to create the custom pressurized treatment fluid via pumping 201.

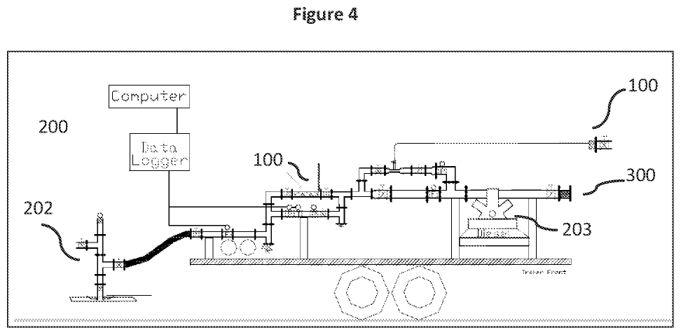

FIG. 4 is another example of the external high-pressure reactor 200 and depicts the general flow sheet with equipment and process for another example of the external first pressurized reactor 200 to create the custom pressurized treatment fluid via use of a compressor 203. FIG. 4 depicts the general flow sheet with equipment 203 (electric, gas, or liquid energy driven motor), adding customized reagents with one or more chemicals, solids, liquids 300 and/or gases 100 to the external first pressurized reactor 200 to create the custom pressurized treatment fluid via use of a compressor.

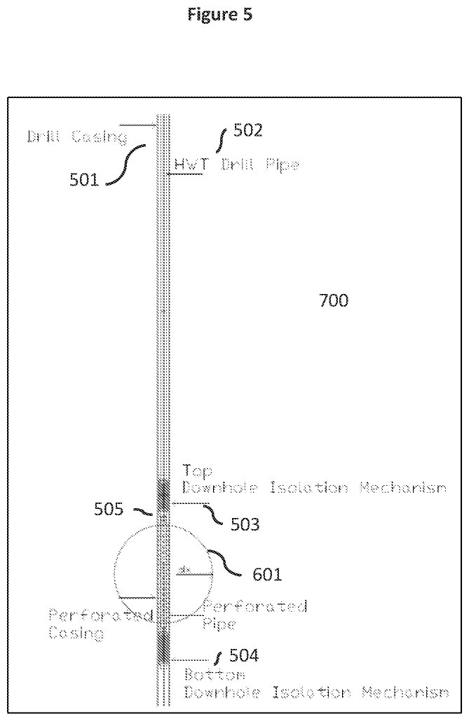

FIG. 5 depicts the well 500 installed in the heap or pile 700 above the bottom of the pile 800, such as the pile of FIG. 1. FIG. 5 shows the perforated portion 505 of the drill casing 501, the top isolation mechanisms 503 and bottom isolation mechanism 504 and the potential zone of influence 601 created by injection of the custom pressurized treatment fluid down the internal piping 502 in the well casing 501 to the perforated zone 505.

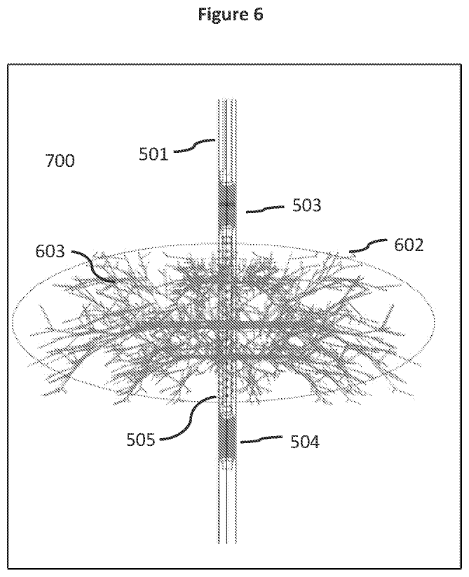

FIG. 6 depicts the well 500 installed in the heap or pile 700 above the bottom of the pile 800 and the second internal pressure reactor 600, such as is found in FIG. 1. FIG. 6 depicts the well casing 501, the top isolation mechanism 503 and bottom isolation mechanism 504 while undergoing injection of the custom pressurized treatment fluid 603 through the perforations 505 in the drill casing 501, expanding within the zone 602 into the heap and pile 700, thereby creating the second internal reactor where one or more of chemical reactions: acid-base, catalytic, coagulation, combination, complexation, dissolution, dissociation, displacement, dispersion, enzymatic, growth, hydrolysis, ionization, compound modification, neutralization, pH, precipitation, polymerization, oxidation, reduction, scale inhibition, chemical stability, and/or substitution. In addition, this second internal reactor can facilitate biological and/or microbiological process and reactions such as biosynthesis, catabolism, cultivation, dispersion, enzymatic, growth, hydrolysis, inoculation, mixing, mutation, adding nutrients, oxidation-reduction, reproduction, respiration, substrate introduction, synthesis, transformation, transportation, and make or modify products, plus physical changes, conditions and processes such as conductivity, density, dispersion, dissolving, drying, filtering, fluidization, mixing, phase changes, polarity, solubility, geotechnical stability, surface tension, particle surface charge, temperature, viscosity, volume and wetting, by mixing and combining the customized pressurized treatment fluid with components 700 in the second internal reactor 602.

FIG. 6 depicts the second internal reactor where one or more of biological, chemical, biochemical, microbiological, and/or physical reactions, process or changes occur due to flow 603 which creates a plurality of substantially near horizontal fluid channels or rechanneling of void spaces 602 in the heap or pile 700 due to the custom pressurized treatment fluid interacting with the heap or pile 700 and creating a zone 602. Embodiments of the systems and methods disclosed herein have demonstrated the observed property of pressurized treatment fluidization that significantly improves the rate of chemical reactions and reagent utilization in situ 602. This improved rate is far greater than the rate of chemical reactions found at atmospheric pressure or room pressure. By increasing the pressure and in situ fluidization, in accordance with embodiments, gas solubility and accompanied reagents, chemicals, minerals, materials and metals solubility in 700 are enhanced. As a result, the reaction and leaching rates are kinetically improved, thereby shifting the equilibrium to designed and desired reaction products at a faster rate than at room pressure in 602, the internal reactor. Examples of some of the reactions are:
Oxidation Example: ferrous iron to ferric iron, Fe⁺² to Fe⁺³.
Reduction Example: Anerobic sulfate reduction to H₂S or sulfides.
Dissolution Example: Improve dissolved oxygen with increased pressure, O_{2(gas)} to O_{2(dissolved)}.
Precipitation Example: Ferric iron precipitation of arsenic from solutions. Fe(OH)₃+H₃AsO₄ to FeAsO₄·2H₂O+H₂O.
Chemical reactions resulting in synthesis, decomposition, replacement, electrochemical, hydration, complexation, acid-base, substitution, with or without a catalyst. Example: Conversion to dissolved hydrogen cyanide to free cyanide by adding a base. HCN+OH⁻ to CN⁻ and H₂O.
Biological Example: microbiological biooxidation of sulfides, or microbiological treatment of cyanide species in water solutions.
Complexation reaction. Example: liquid ammonia and ammonia salts hydrolyze and makes a series of complexes with cyanide, one of which is NH₄CN.
Catalyzed Example: silver catalyzed bio-oxidation of chalcopyrite containing ores.
Physical reactions thereby changing the viscosity, surface tension, and/or wettability of the pressurized treatment fluid impacting the heap or pile. Example: Adding surfactants or surface acting agents that will lower the surface tension between the gas, liquid and solid phases resulting in more particle surface area wetting in the heap impacted by the customized pressurized treatment fluid.
Improved reaction kinetics in the pressurized treatment fluid Example: Cyanide dissolution of gold from a flotation tail is 4 times faster at 90 psi than at room pressure.
pH Example: ammonia to ammonium hydroxide. NH₃+H₂O→NH₄⁺+OH⁻
Eh or oxidation/reduction potential Example: Adding hydrogen peroxide to the treatment fluid as an oxidant.
Ionization Example: Dissolve sodium hydroxide. NaOH(s) to Na⁺+OH⁻.
Scale Inhibitors Example: Precipitant and scale crystal modification in heap leach fluids to reduce the coating of valuable minerals by scale with improved liquid to solid (mineral) surfaces wetting and mineral extraction.

With continued reference FIG. 6, in various embodiments, the rate of custom pressurized treatment fluid injected, plus the physical properties of the heap or pile 700 and the depth of the targeted material or zone controls the geometric shape of the second interior reactor 602 in the zone, such as radius from the well, pressure profile of the treatment fluid, amount of fluidization of the material in the zone 602, and quantity of material impacted by the custom pressurized treatment fluid.

FIG. 6. Laboratory experiments show that leaching a volume of material under high pressure at room temperature is over four times faster than just room pressure leaching. With the higher pressures imparted to the heap or pile during stimulation, even higher leaching kinetics are possible.

While particular embodiments of stacked heap or piles 700 are shown, it will be appreciated that a heap or pile may be planned, designed, permitted, built, and/or constructed with or without containment 800, such that any material may be stacked, conveyed, dumped, and/or placed upon the foundation, liner, or natural contour 800 to leach 700 extract metals and minerals, chemically, biochemically and/or physically alter the materials, contain the materials, promote geotechnical stability, store and/or isolate the material from the environment, and/or promote sound environmental short and long term storage and deposition by the planned integration or use of the technologies. In an example, fluids containing hazardous elements like mercury and arsenic can be precipitated using reagents added at or before the well head, and selectively stored in the void spaces 602 created by the internal second reactor. These stored elements can be leached in the future by altering the injected reagents via the 200 and 600 reactor process. In another example, ground mill tailings can be stored in the created void spaces, e.g., as pumped slurry, or treated during pumping, with reagents entrained in fluid and deposited in the void space in the heap or pile 700. These stored materials can be further treated in the future with other technologies for long term stabilization, storage and disposal or future recovery if market conditions are favorable.

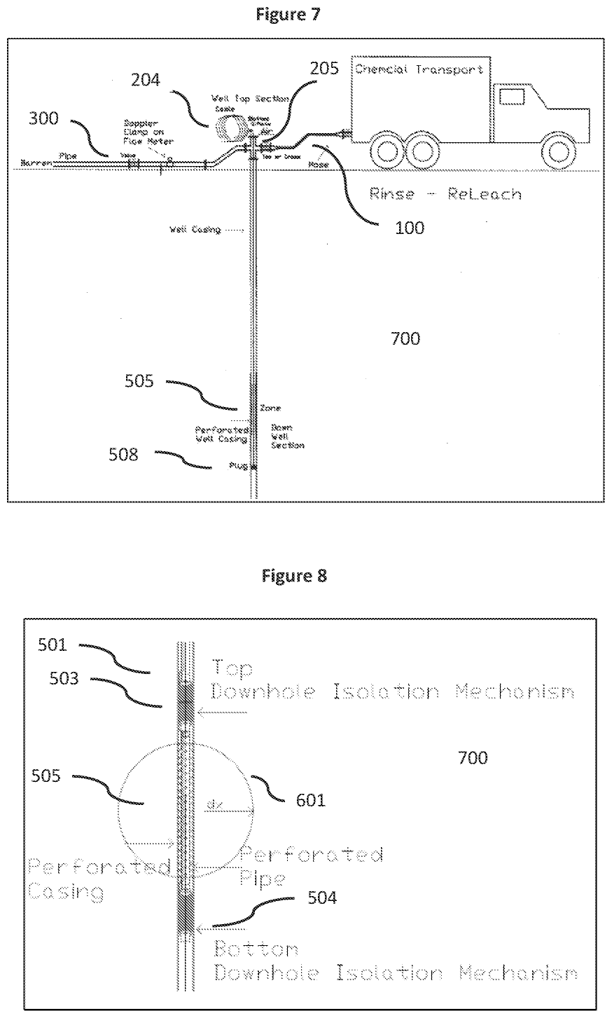

FIG. 7 is an example of the external low-pressure reactor 200. This is another example of 200 in FIG. 1. FIG. 7 depicts the general flow sheet with equipment 204 and process 205 for mixing reagents 100 with other reagents and compounds 300 in the external first low pressurized reactor 205 to create the custom pressurized treatment fluid via the vacuum created 205 by a falling fluid. FIG. 7 also depicts the custom treatment fluid being isolated by a plug, stem, bottom isolation mechanism 508 causing the custom treatment fluid through the perforated well casing 505 into the heap or pile 700. After the introduction of the custom internal pressurized treatment fluid that rechannels 603 in the heap and pile as in FIG. 6, the custom treatment fluid easily flows into the rechanneled voids 603 creating an internal second reactor 602 in the heap 700. This system can also be used for the method of storing meteoric water.

FIG. 7 further depicts 508 as valves, plugs, packers, stems, stents, stoppers, inflated or fluid filled hoses, conduits or pipes can be designed and installed both temporarily or permanently in the 500.

The cased well 500 via use of the perforated zone 505 isolated by a plug 508 can also be rinsed and re-leached periodically to complete the optimal leach cycle in a heap 700.

FIG. 8 depicts a well 500 installed in the heap or pile 700 above the bottom of the pile 800 such as is shown in FIG. 1. FIG. 8 shows the perforated portion 505 of the drill casing 501, the top isolation mechanisms 503 and bottom isolation mechanism 504 and the potential zone of influence 601 created by injection of the custom pressurized treatment fluid down the internal piping 502 in the well casing 501 to the perforated zone 505.

As can be appreciated, the methodologies described herein may be implemented by various methods, depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein may be presented in terms of symbolic representations of operations on binary digital signals stored within a memory of a specific apparatus or special purpose computing device or platform. In the context of this particular specification, the term computer or the like includes a general-purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here and is generally considered to be a self-consistent sequence of operations or similar signal processing leading to a desired result. In this context, operations or processing involve physical manipulation of physical quantities. Typically, although not necessarily, such manipulation of quantities may take the form of electrical, pneumatic, or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “for example,” “an example,” and/or “another example” should be considered to mean that the particular features, structures, or characteristics may be combined in one or more examples.

While there has been illustrated and described what are presently considered to be example features, it will be understood by those skilled in the art that various other modifications may be made, and equivalents may be substituted, without departing from the disclosed subject matter. Well known process steps and structures have not been described in detail in order to not unnecessarily obscure the other descriptions provided herein. Additionally, many modifications may be made to adapt a particular situation to the teachings of the disclosed subject matter without departing from the central concept described herein. Therefore, it is intended that the disclosed subject matter not be limited to the particular examples disclosed.

What is claimed is:

1. A system comprising an external high pressure reactor for pressurizing a treatment fluid exterior to a heap or pile, and creating a second internal high pressure reactor in the heap or pile, via flowing a customized pressurized treatment fluid from the external high-pressure reactor to the second internal high pressure reactor thereby improving the system's reaction kinetics in both reactors.

2. A reactor system comprising:
an exterior high pressure reactor disposed external to a heap or pile;
one or more conduits extending from the exterior high pressure reactor into an interior of the heap or pile:
a drilled well casing positioned substantially vertically within the heap or pile, and coupled to the one or more conduits, the drilled well casing comprising an open top, an open or closed bottom, and at least one perforation zone comprising a plurality of perforations along a vertical section of the drilled well casing;
a pipe positioned within the drilled well casing, the pipe configured to receive a customized pressurized treatment fluid;
one or more isolation mechanisms configured to seal the drilled well casing above and/or below the at least one perforation zone to isolate a first flow of the customized pressurized treatment fluid through perforations among the plurality of perforations, wherein a pressurized flow of the customized pressurized treatment fluid creates a second internal high pressure reactor that fluidizes materials within the interior of the heap or pile, and creates a plurality of substantially near horizontal fluid channels, thereby rechanneling fluid pathways through the materials within the interior of the heap or pile.

3. The system of claim 1 or 2, wherein the customized pressurized treatment fluid comprises one or more solids, liquids, gases, anions, bacteria, catalysts, cations, chemicals, elements, enzymes, hazardous materials, inorganic solutions, lixiviants, organic solutions, penalty metals, reagents, scale inhibitors, slurries, inorganic solvents, organic solvents, or surfactants.

4. The system of claim 1 or 2, wherein the customized pressurized treatment fluid comprises reagents to leach a target material or zone from the heap or pile.

5. The system of claim 1 or 2, wherein the customized pressurized treatment fluid comprises reagents to change the biology, biochemistry, chemistry, or microbiology of a target material or zone in the heap or pile.

6. The system of claim 1 or 2, wherein the customized pressurized treatment fluid comprises reagents to change the physical properties of a target material or zone in the heap or pile.

7. The system of claim 1 or 2, wherein the customized pressurized treatment fluid comprises reagents to change one or more of the biology, biochemistry, chemistry, or microbiology properties of a target material from the heap or pile.

8. The system of claim 2, wherein the customized pressurized treatment fluid is mixed, fluidized, and pressurized in the exterior high pressure reactor.

9. The system of claim 2, wherein the customized pressurized treatment fluid is pumped and conveyed by the one or more conduits to a well head for injection into the interior of the heap or pile.

10. The system of claim 2, wherein the customized pressurized treatment fluid is compressed by a compressor for conveyance by the one or more conduits to a well head for injection into the interior of the heap or pile.

11. The system of claim 2, wherein the customized pressurized treatment fluid is produced in the exterior high pressure reactor by mixing and combining one or more reagents under pressure to facilitate one or more of biological, chemical, or microbiological reactions, and optionally physical changes in the customized pressurized treatment fluid.

12. The system of claim 11, wherein in each reactor, the customized pressurized treatment fluid undergoes one or more reactions.

13. The system of claim 12, wherein the one or more reactions are selected from acid-base, catalytic, coagulation, combination, complexation, dissolution, dissociation, displacement, dispersion, enzymatic, growth, hydrolysis, ionization, compound modification, neutralization, pH, precipitation, polymerization, oxidation, reduction, scale inhibition, chemical stability, or substitution reactions.

14. The system of claim 12, wherein the exterior high pressure reactor facilitates one or more biological or microbiological processes within the customized pressurized treatment fluid.

15. The system of claim 14, wherein the one or more biological or microbiological processes are selected from biosynthesis, catabolism, cultivation, dispersion, enzymatic, growth, hydrolysis, inoculation, mixing, mutation, adding nutrients, oxidation-reduction, reproduction, respiration, substrate introduction, synthesis, transformation, or transportation.

16. The system of claim 12, wherein the exterior high pressure reactor facilitates one or more physical changes to the customized pressurized treatment fluid.

17. The system of claim 16, wherein the one or more physical changes are selected from conductivity, density, dispersion, dissolving, drying, filtering, fluidization, mixing, phase changes, polarity, solubility, geotechnical stability, surface tension, particle surface charge, temperature, viscosity, volume, and wetting.

18. The system of claim 2, wherein the customized pressurized treatment fluid is fluidized, mixed, and reacts in the second internal high pressure reactor with the material in the interior of the heap or pile, under pressure.

19. The system of claim 18, wherein the second internal high pressure reactor facilitates one or more biological, chemical, or microbiological reactions to the customized pressurized treatment fluid.

20. The system of claim 19, wherein the second internal high pressure reactor further facilitates one or more physical changes to the customized pressurized treatment fluid by fluidizing, mixing, or combining reagents under pressure with a target material or zone in the interior of the heap or pile.

21. The system of claim 2, wherein one or more of a concentration of reagents, quantity, flows, mass, and rate of mass introduction, together with biological, chemical, microbiological, or physical properties of the customized pressurized treatment fluid conveyed and injected into a targeted material or zone will control one or more of a rate and yield of reactions, processes, properties, and conditions in the second internal high pressure reactor in the interior of the heap or pile.

22. The system of claim 12, wherein one or more of the biological, chemical, microbiological, or physical reactions or changes occurs in the second internal high pressure reactor created in a target material or zone in the interior of the heap or pile, in response to zonal fluidization resulting from the custom pressurized treatment fluid, and thereby reacts to one or more of the biological, chemical, microbiological, and physical properties of the target material or zone.

23. The system in claim 12, wherein the second internal high pressure reactor further facilitates one or more chemical or metabolic reactions which facilitates removal of desired components in the customized pressurized treatment fluid for retention or storage in the heap or pile.

24. The system of claim 12, wherein the customized pressurized treatment fluid's quantity, flow, or mass controls the dimensions, size, shape, volume, or pressure profile of the second internal high pressure reactor within a target material or zone in the interior of the heap or pile, thereby controlling a mass and volume of material in the heap or pile, impacted by the customized treatment fluid.

25. The system of claim 2, wherein the exterior high pressure reactor, the one or more conduits, the drilled well casing, and the pipe comprise materials that are selected to contain and facilitate one or more biological, chemical, or microbiological reactions under pressure and then convey the customized pressurized treatment fluid to the second internal high pressure reactor in the interior of the heap or pile.

26. The system of claim 25, wherein the materials are selected for one or more of the following properties: to reduce or eliminate abrasion, availability, compression, corrosion, cost, degradation, ease of fabrication and continued use, elongation, fractures, shear, safety, tension, or wear.

27. The system of claim 2, wherein the customized pressurized treatment fluid completes one or more first processes of biology, biochemistry, chemistry, or microbiology reactions in the targeted material or zone in the interior of the heap or pile, then after a period of time the customized pressurized treatment fluid completes one or more second processes of biology, biochemistry, chemistry, or microbiology reactions in the targeted material or zone in the interior of the heap or pile.

28. The system of claim 2, wherein the second internal high pressure reactor comprises a plurality of stages of treatment, each stage having one or more different biological, biochemical, chemical, or microbiological reactions in a targeted material in the interior of the heap or pile.

29. A reactor system comprising:
an exterior low pressure reactor disposed external to a heap or pile;
one or more conduits extending from the exterior low pressure reactor into an interior of the heap or pile;
a drilled well casing positioned substantially vertically within the heap or pile, and coupled to the one or more conduits, the drilled well casing comprising an open top, an open or closed bottom, and at least one perforation zone comprising a plurality of perforations along a vertical section of the drilled well casing;
an isolation mechanism configured to seal the drilled well casing below the at least one perforation zone to isolate and direct a first flow of falling customized treatment fluid through perforations among the plurality of perforations, wherein falling flow of customized treatment fluid creates a vacuum at the top of the well casing or well head and creates a second internal reactor within an interior of the heap or pile, that impacts materials within the interior of the heap or pile, and partially or completely fills a plurality of substantially near horizontal fluid channels, thereby wetting and dispersing the customized treatment fluid to the materials in a zone in the interior of the heap or pile.

30. The system of claim 29, wherein the customized treatment fluid is formed by falling down the well casing and creating a vacuum at the well head which draws in reagents from nearby reservoirs to make the custom treatment fluid and then mix such custom treatment fluid while falling down the well casing, after which the customized treatment fluid is passed through the perforations to a target material or zone in the heap or pile.

31. The system of claim 30, further comprising flow controls on a pressurized fluid at the well head to vary the amount of vacuum created by the falling fluid.

32. The system of claim 31, further comprising one or more additional control valves to dose the reagents to the exterior low pressure reactor.

33. The system of claim 29, wherein in each reactor, the customized treatment fluid undergoes one or more reactions.

34. The system of claim 33, wherein the one or more reactions are selected from acid-base, catalytic, coagulation, combination, complexation, dissolution, dissociation, displacement, dispersion, enzymatic, growth, hydrolysis, ionization, compound modification, neutralization, pH, precipitation, polymerization, oxidation, reduction, scale inhibition, chemical stability, or substitution reactions.

35. The system of claim 33, wherein the exterior low pressure reactor facilitates one or more biological or microbiological processes within the customized pressurized treatment fluid.

36. The system of claim 35, wherein the one or more biological or microbiological processes are selected from biosynthesis, catabolism, cultivation, dispersion, enzymatic, growth, hydrolysis, inoculation, mixing, mutation, adding nutrients, oxidation-reduction, reproduction, respiration, substrate introduction, synthesis, transformation, or transportation.

37. The system of claim 33, wherein the exterior low pressure reactor facilitates one or more physical changes to the customized pressurized treatment fluid.

38. The system of claim 33, wherein meteoric water is conveyed to the top of the well head to the interior of the pile for storage and retention.

39. The system of claim 1, 2, or 29, wherein the heap or pile, is above one or more of a foundation, a collection system, a liner, a natural contour of native earth, or compacted native earth.

40. The system of claim 2 or 29, wherein the isolation mechanism comprises one or more of a plug, stop, packer, inflatable packer, mechanical packer, or stem to seal the drilled well casing.

41. The system of claim 1, 2, or 29, wherein the system controls an amount of air or humidity entering and/or exiting a well head, thereby entering, or exiting the heap or pile, by one or more processes, pressure, equipment, vacuum, or natural convection to control the rate of additional chemical and biochemical reactions in the pile.

42. The system of claim 2 or 29, wherein the open top, the open or closed bottom, or both the open top and the open or closed bottom are configured to be sealed to temporarily or permanently protect short or long-term pile stability by preventing the drilled well casing from being exposed to air, meteoric water, bacteria, yeasts, molds, or human interaction.

43. The system of claim 1, 2, or 29, wherein the internal reactor facilitates one or more of: an oxidation reaction within the heap or pile; a reduction reaction within the heap or pile; a precipitation within the heap or pile; a dissolution reaction within the heap or pile; a chemical reaction within the heap or pile; changing the pH in the treatment fluid thereby impacting the heap or pile; a complexation reaction thereby changing a chemistry in the treatment fluid which will impact the heap or pile; a biological reaction within the heap or pile; a catalyzed reaction within the heap or pile; a physical reaction within the heap or pile thereby changing a viscosity, surface tension, or wettability of a targeted material or zone in the heap or pile; improved reaction dissolution kinetics in the treatment fluid thereby impacting target material or zone in the heap or pile; changing the oxidation/reduction potential in the treatment fluid thereby impacting the heap or pile; dissociation and ionization in the treatment fluid thereby impacting the heap or pile; or adding scale inhibition in the treatment fluid thereby impacting the heap or pile.

44. The system of claim 2 or 29, further comprising one or more of vessels to house reagents to feed the system to make up the custom treatment fluid.

45. The system of claim 44, wherein the one or more vessels comprise bags, bins, bottles, conduits, sacks, skids, silos, tanks, totes, or trucks.

46. The system of claim 44, further comprising one or more of: agitators, augers, compressors, conduits, controls, conveyors, feeders, hoppers, hoses, instruments, mixers, pipes and fittings, pumps, screws, valves, or stockpiles to supply reagents to the system.
